(19) United States
(12) Patent Application Publication
(10) Pub. No.: US 2009/0171687 A1
(43) Pub. Date: Jul. 2, 2009

(54) Identifying Industry Passionate Consumers

(75) Inventors: Karlyn Heiner CROTTY, Pennington, NJ (US); Prashant Kalia, Fair Lawn, NJ (US); Suby P. Philip, East Meadow, NY (US); Danny M. Yelle, Stamford, CT (US)

Correspondence Address: STERNE, KESSLER, GOLDSTEIN & FOX, P.L.L.C., 1100 NEW YORK AVENUE, N.W., WASHINGTON, DC, 20005-3934, US

(73) Assignee: American Express Travel Related Services Company, Inc., New York, NY (US)

(21) Appl. No.: 12/144,506

(22) Filed: Jun. 23, 2008

Related U.S. Application Data
(60) Provisional application No. 61/018,136, filed on Dec. 31, 2007.

(51) Int. Cl. G06Q 99/00

(52) U.S. Cl. 705/1

(57) ABSTRACT

Transaction-level data and size of wallet data may be used to identify industry passionate consumers. In an embodiment, industry passionate consumers are identified based on a ratio of spend within an industry to total spend of the consumer. In another embodiment, industry passionate consumers are identified based on a modeling of the consumer's wallet and determining the ratio of spend within an industry to total spend of the consumer. The consumers may be ranked according to their ratios, with the consumers having the highest ratios being identified as industry passionate consumers.

### CROSS REFERENCE TO RELATED APPLICATIONS

This application claims priority under 35 U.S.C. §119(e) to U.S. Provisional Patent Application No. 61/018,136 filed Dec. 31, 2007, which is incorporated by reference herein in its entirety.

### BACKGROUND

1. Field of the Invention

The present invention relates to consumer segmentation, specifically consumer segmentation for marketing purposes.

2. Related Art

Certain individuals tend to spend more of their available funds in one particular industry than other industries. Such individuals are referred to as “industry passionate.” As these individuals are more likely to spend their available funds in the particular industry as compared to the average individual, industry passionates are more likely to respond to opportunities and incentives that encourage their spending. However, it has been difficult for advertisers to accurately identify individuals who are passionate about spending on products in a specific industry category and offer relevant products to them.

### BRIEF DESCRIPTION OF THE DRAWINGS/FIGURES

The accompanying drawings, which are incorporated herein and form a part of the specification, illustrate the present invention and, together with the description, further serve to explain the principles of the invention and to enable a person skilled in the pertinent art to make and use the invention.

FIG. 1 is a flowchart of a method for identifying industry passionate consumers according to an embodiment of the present invention.

FIG. 2 is a diagram further illustrating an exemplary industry passionate consumer selection.

FIG. 3 is a flowchart of a modeling process used according to an embodiment of the present invention.

FIG. 4 is a flowchart illustrating industry passionate consumer identification processes for minority share consumers according to an embodiment of the present invention.

FIG. 5 is a block diagram of an exemplary computer system useful for implementing the present invention.

FIG. 6 is an illustration of an industry passionate consumer identification system according to an embodiment of the present invention.

The present invention will be described with reference to the accompanying drawings. The drawing in which an element first appears is typically indicated by the leftmost digit(s) in the corresponding reference number.

### DETAILED DESCRIPTION

### I. Overview

While specific configurations and arrangements are discussed, it should be understood that this is done for illustrative purposes only. A person skilled in the pertinent art will recognize that other configurations and arrangements can be used without departing from the spirit and scope of the present invention. It will be apparent to a person skilled in the pertinent art that this invention can also be employed in a variety of other applications.

The terms “user,” “end user,” “consumer,” “customer,” “participant,” and/or the plural form of these terms are used interchangeably throughout herein to refer to those persons or entities capable of accessing, using, being affected by and/or benefiting from the tool that the present invention provides for identifying industry passionate consumers.

Furthermore, the terms “business” or “merchant” may be used interchangeably with each other and shall mean any person, entity, distributor system, software, and/or hardware that is a provider, broker and/or any other entity in the distribution chain of goods or services. For example, a merchant may be a grocery store, a retail store, a travel agency, a service provider, an on-line merchant or the like.

### 1. Transaction Accounts and Instrument

A “transaction account” as used herein refers to an account associated with an open account or a closed account system (as described below). The transaction account may exist in a physical or non-physical embodiment. For example, a transaction account may be distributed in non-physical embodiments such as an account number, frequent-flyer account, and telephone calling account or the like. Furthermore, a physical embodiment of a transaction account may be distributed as a financial instrument.

A financial transaction instrument may be traditional plastic transaction cards, titanium-containing, or other metal-containing, transaction cards, clear and/or translucent transaction cards, foldable or otherwise unconventionally sized transaction cards, radio-frequency enabled transaction cards, or other types of transaction cards, such as credit, charge, debit, pre-paid or stored-value cards, or any other like financial transaction instrument. A financial transaction instrument may also have electronic functionality provided by a network of electronic circuitry that is printed or otherwise incorporated onto or within the transaction instrument (and typically referred to as a “smart card”), or be a fob having a transponder and an RFID reader.

### 2. Open Versus Closed Cards

“Open cards” are financial transaction cards that are generally accepted at different merchants. Examples of open cards include the American Express®, Visa®, MasterCard®, and Discover® cards, which may be used at many different retailers and other businesses. In contrast, “closed cards” are financial transaction cards that may be restricted to use in a particular store, a particular chain of stores or a collection of affiliated stores. One example of a closed card is a pre-paid gift card that may only be purchased at, and only be accepted at, a clothing retailer, such as The Gap® store.

### 3. Stored Value Cards

Stored value cards are forms of transaction instruments associated with transaction accounts, wherein the stored value cards provide cash equivalent value that may be used within an existing payment/transaction infrastructure. Stored value cards are frequently referred to as gift, pre-paid or cash cards, in that money is deposited in the account associated with the card before use of the card is allowed. For example, if a customer deposits ten dollars of value into the account associated with the stored value card, the card may only be used for payments together totaling no more than ten dollars.

### 4. Use of Transaction Accounts

With regard to use of a transaction account, users may communicate with merchants in person (e.g., at the box office), telephonically, or electronically (e.g., from a user computer via the Internet). During the interaction, the merchant may offer goods and/or services to the user. The merchant may also offer the user the option of paying for the goods and/or services using any number of available transaction accounts. Furthermore, the transaction accounts may be used by the merchant as a form of identification of the user. The merchant may have a computing unit implemented in the form of a computer-server, although other implementations are possible.

In general, transaction accounts may be used for transactions between the user and merchant through any suitable communication means, such as, for example, a telephone network, intranet, the global, public Internet, a point of interaction device (e.g., a point of sale (POS) device, personal digital assistant (PDA), mobile telephone, kiosk, etc.), online communications, off-line communications, wireless communications, and/or the like.

Persons skilled in the relevant arts will understand the breadth of the terms used herein and that the exemplary descriptions provided are not intended to be limiting of the generally understood meanings attributed to the foregoing terms.

It is noted that references in the specification to “one embodiment”, “an embodiment”, “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect such feature, structure, or characteristic in connection with other embodiments whether or not explicitly described.

### II. Identifying Industry Passionate Consumers

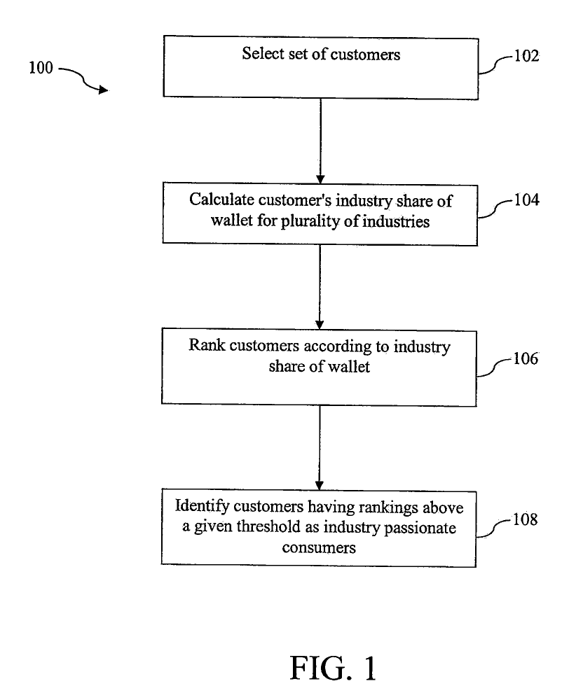

Industry passionate consumers are those customers who spend a significantly higher portion of their wallet in a particular industry compared to their peers. Although industry passionate consumers are often high-wallet customers, one of skill in the art will recognize that there is no wallet-size requirement for a customer to be identified as an industry passionate consumer, although industry passionate consumers may be identified within bands or ranges based on comparable sizes of wallet. FIG. 1 is a flowchart of a method 100 of identifying industry passionate consumers, according to an embodiment of the present invention.

In step 102, a set of customers is selected. The set may include, for example, all customers of a financial transaction company such as American Express Co., of New York, N.Y. In another example, the set may include a subset of all customers of the financial transaction company.

In step 104, an industry share of wallet for a given industry is calculated for each customer. In an embodiment, a given customer's industry share of wallet is determined by calculating the ratio of the customer's spend within an industry to the customer's total wallet. The total size of wallet is the entire amount of spend by a particular consumer from sources, as an example, tradeline data sources, over a given period. The total size of wallet of a consumer may be calculated based on, for example and without limitation, internal customer tradeline data and/or external tradeline data available from, for example, a credit bureau.

A customer's spend within an industry, also referred to as an industry share of wallet, is the amount a customer spends within a particular industry. A transactional account company (also referred to herein as a financial institution) may have a record of the consumer's spend by industry. However, if such a record does not exist, the transactional account company can, for example, analyze the records of charge of each consumer in the subset of consumers to determine the industry-related spending habits of each consumer. Types of industries may include industries at a macro level, for example and without limitation, the travel industry, the restaurant industry, and the entertainment industry. Types of industries may also include industries at a micro level, for example and without limitation, the airline industry, the lodging industry, and the car rental industry, each of which is a subset of a macro industry, such as the travel industry.

An exemplary method and system for calculating a customer's industry share of wallet is further described in U.S. patent application Ser. No. 11/608,179, filed Dec. 7, 2006, which is incorporated herein by reference in its entirety.

In step 106, each customer in the set of customers is ranked according to their industry share of wallet within a particular industry as illustrated above. As an example, if the industry being analyzed is that of fashion, then the spending history of all customers of a financial transaction company are analyzed for spending within the fashion industry. This is done by computing, for each customer, the ratio of fashion spending to the total spending for a particular period. Given this ratio, in step 106 the customer is ranked. In an embodiment used herein as an example, the higher the ranking is, the greater the proportion of a customer's total spend is in the particular industry.

In step 108, customers ranked above a given threshold for a particular industry are determined to be industry passionate consumers. For example, the top 25% of customers may be identified as industry passionate consumers. Thresholds may not be the same between multiple industries. However, a threshold is determined whereby those consumers which have a ranking above a particular threshold for a specific industry have a disproportionate share of their wallet being spent within that industry. Thresholds can be determined by historical spending patterns as well as statistical analysis, trend analysis, and other mathematical modeling techniques.

In addition, steps 106 and 108 utilize a ranking based on a ratio so that customers are identified as industry passionate consumers because of the overall proportion of a customer's wallet that is spent within an industry, not the absolute dollar amount. This is done, for example, because a customer who spends one million dollars within an industry within a year, but who has a total size of wallet of five million dollars, only has a 20% industry share. In an industry that indicates a person is industry passionate when greater than 25% of their wallet is spent in a particular industry, the one million dollars would not qualify as industry passionate.

To ensure that the industry passionate groups are not skewed toward customers with either very high wallets or very low wallets, the determination of method 100 may be run on different segments of customers. For example, one segment of customers for which industry passion can be determined are customers having sizes of wallet between approximately $30,000 and $80,000. In this example, a second segment of customers for which industry passion can be determined are customers having sizes of wallet greater than approximately $80,000. One of skill in the art will recognize that other wallet sizes may be used without departing from the spirit and scope of the present invention.

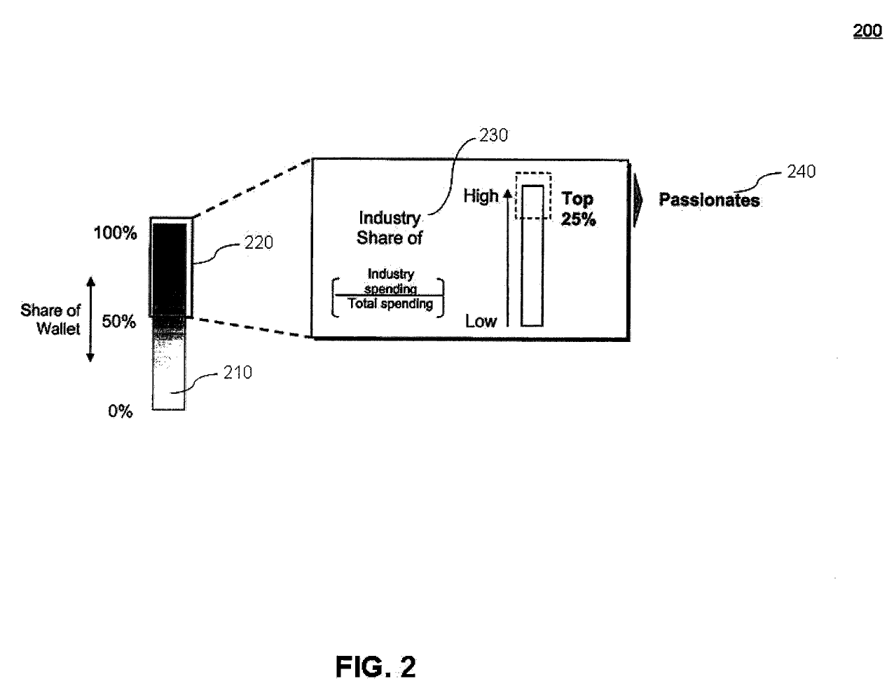

FIG. 2 is a diagram further illustrating an exemplary industry passionate consumer selection. Share of wallet 210 represents the entire wallet of a customer as defined above. However, customers may spend their wallets through a number of financial institutions. In this embodiment, only those customers that spend approximately 50% or greater of their wallets with a single financial transaction company as indicated by the area 220 are analyzed in regards to their industry spending actions. Within those customers that spend greater than approximately 50% within a financial transaction company, the industry share of wallet 230 is calculated as the ratio of industry spending over total spending wherein those with the highest 25% of ratios are determined to be passionates 240.

Method 100 may be performed, for example, for customers having a majority share of wallet with the financial transaction company (that is, more than 50% of the customer's transactions are with the financial transaction company), so that the financial transaction company has sufficient knowledge of the customer's transactions. In an embodiment, customers having a majority share of wallet with the financial transaction company, but with no financial activity within a specific industry in a specific period, may not be selected and analyzed for that given industry and time period. In another embodiment, a company may wish to target minority share customers (that is, less than 50% of the customer's transactions are with the financial transaction company). In such a situation, the financial transaction company may not have sufficient transactional data on the minority share customer to make an accurate industry passionate determination. Customer modeling may then be used in addition to or instead of method 100 to estimate a customer's industry spend.

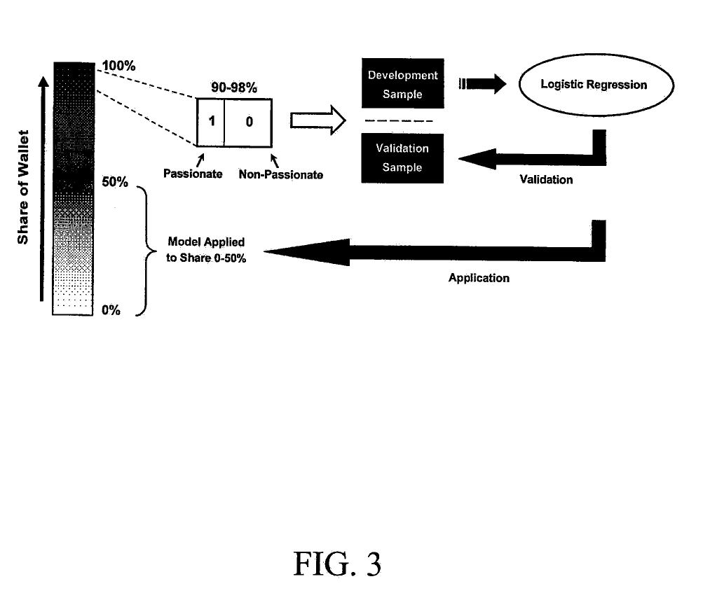

An industry passionate model may be developed using, for example, attributes of customers having a high share of wallet with the financial transaction company. FIG. 3 is a flowchart illustrating the modeling process according to an embodiment of the present invention. In the embodiment of FIG. 3, high share of wallet customers include those customers having 90% to 98% share of wallet with the financial transaction company. For purposes of modeling, it is assumed that customers who have the same attributes spend in similar manners and patterns. Accordingly, minority share customers having attributes similar to identified industry passionate consumers may be determined to be industry passionate consumers based on such modeling. Exemplary industry wallet modeling is further described in U.S. patent application Ser. No. 11/608,179, filed Dec. 7, 2006, which is incorporated herein by reference in its entirety.

A minority share customer may be analyzed using the model alone, using the method described with respect to FIG. 1 alone, or using both the model and the method. The process used for the analysis may be based on the share of wallet the consumer has with the financial transaction company. For example, if the customer has less than, for example, a 25% share with the financial transaction company, there may not be enough transaction-level data to run method 100. In this case, the customer may be analyzed using the model alone. If the customer has a share of wallet with the financial transaction company between, for example, 25% and 50%, a combination of both the model and method 100 may be used. For example, in one embodiment, modeling is used to estimate a minority share customer's industry share of wallet, which can then be ranked in conjunction with method 100 to determine whether the minority share customer is an industry passionate consumer. If the customer has a share of wallet greater than, for example, 50% with the financial transaction company, the customer may be analyzed using method 100 alone.

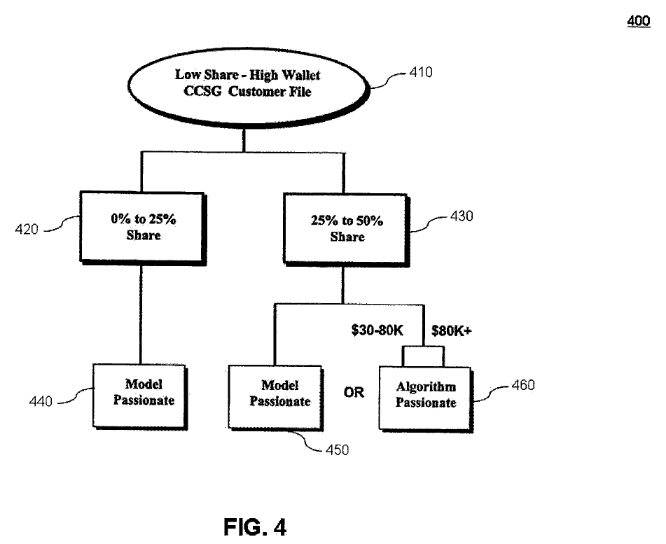

FIG. 4 is a flowchart further illustrating industry passionate consumer identification processes for minority share consumers, according to an embodiment of the present invention. FIG. 4 represents a method 400 for high wallet customers that maintain a share of wallet with the financial transaction company of less than approximately 50%. These customers are represented by data within the low share—high wallet customer file 410. In this embodiment, the low share—high wallet customers are further segmented by their share of wallet. In this embodiment, low share—high wallet customers with a 0% to 25% share are represented by consumer block 420, while those minority share consumers with a 25% to 50% share are represented by consumer block 430. Consumers in 0% to 25% share consumer block 420 are analyzed using behavioral modeling at block 440, as the financial transaction company does not have sufficient information on such a consumer to accurately model their spending patterns. However, those 25% to 50% share 430 consumers can be analyzed using either behavioral modeling at block 450, or an industry spend analysis at block 460, such as method 100 of FIG. 1. In yet another embodiment, a combination of both behavioral modeling at block 450 and spend analysis at block 460 is used to determine the spend attributes of a 25% to 50% share 430 consumer.

Once at least one industry passionate consumer has been identified, the industry passionate consumer may be targeted with marketing and/or promotional items by, for example, a financial transaction company. For example, industry passionate consumers may be more receptive to offers tied to their industry of interest such as, for example and without limitation, balance transfer offers, membership rewards redemption offers, custom merchant offers, and online offers.

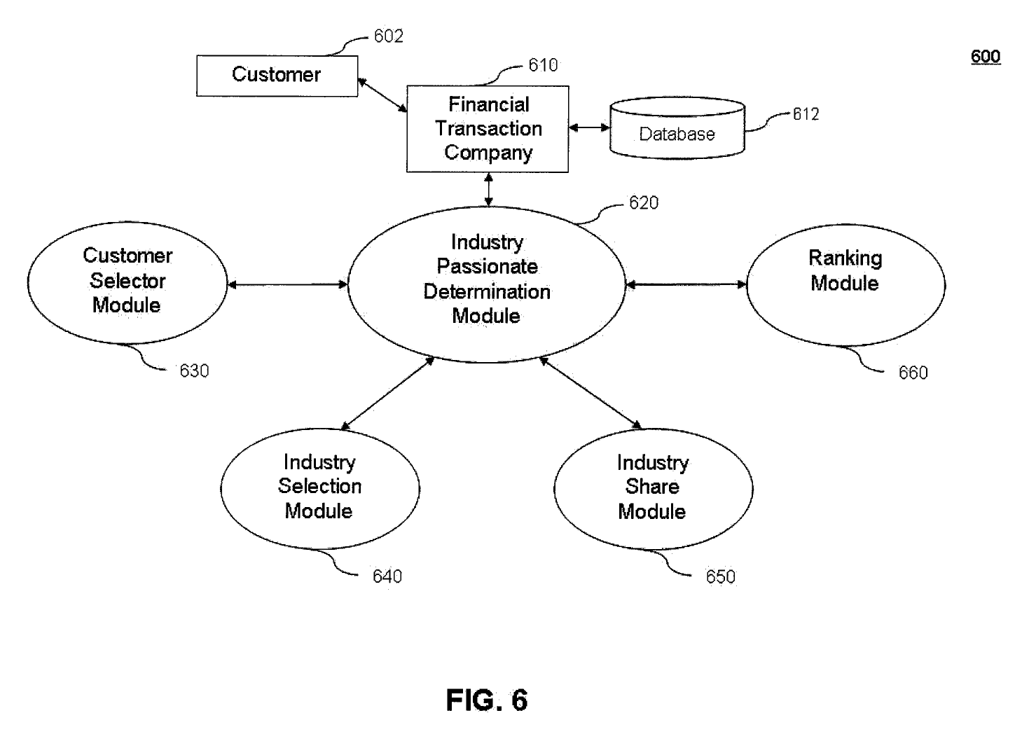

FIG. 6 is an illustration of an industry passionate consumer identification system 600 according to an embodiment of the present invention. A customer 602 maintains a transaction account with a financial transaction company 610, and thus has a share of wallet with that financial transaction company. In turn, financial transaction company 610 maintains records relating to customer 602's transactions within database 612.

In an embodiment, in order for industry passionate determination module 620 to determine whether customer 602 is an industry passionate consumer, customer selector module 630, industry selection module 640, industry share module 650, and ranking module 660 are utilized to analyze specific industry and customer information. In an embodiment, customer selector module 630 identifies customer 602, which maintains a share of wallet with the financial transaction company 610. Once customer 602 is identified, industry selection module 640 identifies an industry where customer 602 spends a portion of customer 602's wallet from information stored within database 612. Industry share module 650 then calculates an industry share of wallet for customer 602. Ranking module 660 is responsible for ranking the spending history of customer 602 within the industry selected by industry selection module 640 in order to determine customer 602's industry share of wallet. Industry passionate determination module 620 is configured to accept information from customer selector module 630, industry selection module 640, industry share module 650, and ranking module 660 in order to determine whether customer 602 is an industry passionate consumer based on customer 602's industry share of wallet.

### III. Example Implementations

The present invention or any part(s) or function(s) thereof may be implemented using hardware, software or a combination thereof and may be implemented in one or more computer systems or other processing systems. However, the manipulations performed by the present invention were often referred to in terms, such as adding or comparing, which are commonly associated with mental operations performed by a human operator. No such capability of a human operator is necessary, or desirable in most cases, in any of the operations described herein which form part of the present invention. Rather, the operations are machine operations. Useful machines for performing the operation of the present invention include general-purpose digital computers or similar devices.

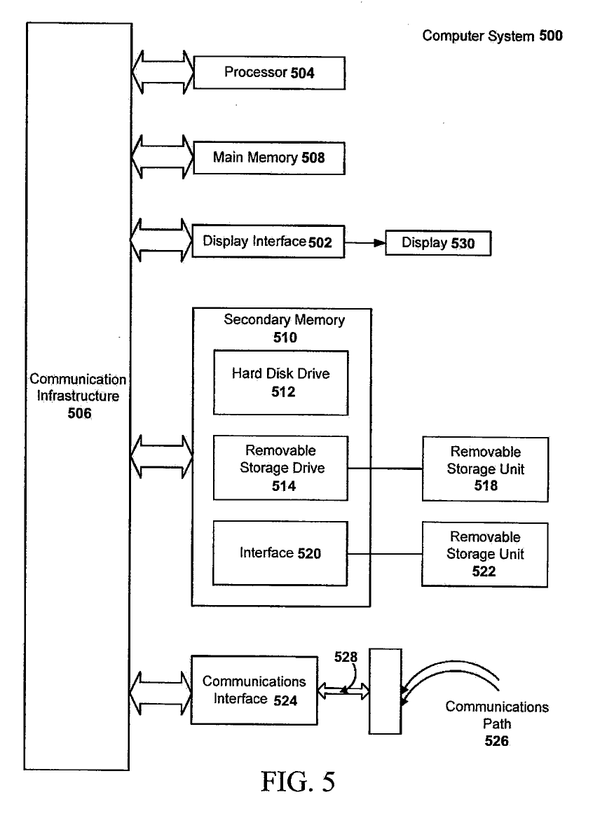

In fact, in one embodiment, the invention is directed toward one or more computer systems capable of carrying out the functionality described herein. An example of a computer system 500 is shown in FIG. 5.

The computer system 500 includes one or more processors, such as processor 504. The processor 504 is connected to a communication infrastructure 506 (e.g., a communications bus, cross-over bar, or network). Various software embodiments are described in terms of this exemplary computer system. After reading this description, it will become apparent to a person skilled in the relevant art(s) how to implement the invention using other computer systems and/or architectures.

Computer system 500 can include a display interface 502 that forwards graphics, text, and other data from the communication infrastructure 506 (or from a frame buffer not shown) for display on the display unit 530.

Computer system 500 also includes a main memory 508, preferably random access memory (RAM), and may include a secondary memory 510. The secondary memory 510 may include, for example, a hard disk drive 512 and/or a removable storage drive 514, representing a floppy disk drive, a magnetic tape drive, an optical disk drive, etc. The removable storage drive 514 reads from and/or writes to a removable storage unit 518 in a well-known manner. Removable storage unit 518 represents a floppy disk, magnetic tape, optical disk, etc. which is read by and written to by removable storage drive 514. As will be appreciated, the removable storage unit 518 includes a computer usable storage medium having stored therein computer software and/or data.

In alternative embodiments, secondary memory 510 may include other similar devices for allowing computer programs or other instructions to be loaded into computer system 500. Such devices may include, for example, a removable storage unit 522 and an interface 520. Examples of such may include a program cartridge and cartridge interface (such as that found in video game devices), a removable memory chip (such as an erasable programmable read only memory (EPROM), or programmable read only memory (PROM)) and associated socket, and other removable storage units 522 and interfaces 520, which allow software and data to be transferred from the removable storage unit 522 to computer system 500.

Computer system 500 may also include a communications interface 524. Communications interface 524 allows software and data to be transferred between computer system 500 and external devices. Examples of communications interface 524 may include a modem, a network interface (such as an Ethernet card), a communications port, a Personal Computer Memory Card International Association (PCMCIA) slot and card, etc. Software and data transferred via communications interface 524 are in the form of signals 528, which may be electronic, electromagnetic, optical, or other signals capable of being received by communications interface 524. These signals 528 are provided to communications interface 524 via a communications path (e.g., channel) 526. This channel 526 carries signals 528 and may be implemented using wire or cable, fiber optics, a telephone line, a cellular link, a radio frequency (RF) link and other communications channels.

In this document, the terms “computer program medium” and “computer usable medium” are used to generally refer to media such as removable storage drive 514 and a hard disk installed in hard disk drive 512. These computer program products provide software to computer system 500. The invention is directed to such computer program products.

Computer programs (also referred to as computer control logic) are stored in main memory 508 and/or secondary memory 510. Computer programs may also be received via communications interface 524. Such computer programs, when executed, enable the computer system 500 to perform the features of the present invention, as discussed herein. In particular, the computer programs, when executed, enable the processor 504 to perform the features of the present invention. Accordingly, such computer programs represent controllers of the computer system 500.

In an embodiment where the invention is implemented using software, the software may be stored in a computer program product and loaded into computer system 500 using removable storage drive 514, hard drive 512 or communications interface 524. The control logic (software), when executed by the processor 504, causes the processor 504 to perform the functions of the invention as described herein.

In another embodiment, the invention is implemented primarily in hardware using, for example, hardware components such as application specific integrated circuits (ASICs). Implementation of the hardware state machine so as to perform the functions described herein will be apparent to persons skilled in the relevant art(s).

In yet another embodiment, the invention is implemented using a combination of both hardware and software.

### IV. Conclusion

While various embodiments of the present invention have been described above, it should be understood that they have been presented by way of example, and not limitation. It will be apparent to persons skilled in the relevant art(s) that various changes in form and detail can be made therein without departing from the spirit and scope of the present invention. Thus, the present invention should not be limited by any of the above-described exemplary embodiments, but should be defined only in accordance with the following claims and their equivalents.

In addition, it should be understood that the figures and screen shots illustrated in the attachments, which highlight the functionality and advantages of the present invention, are presented for example purposes only. The architecture of the present invention is sufficiently flexible and configurable, such that it may be utilized (and navigated) in ways other than that shown in the accompanying figures.

Further, the purpose of the foregoing Abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The Abstract is not intended to be limiting as to the scope of the present invention in any way.

What is claimed is:

1. A computer-implemented method of identifying industry passionate consumers, comprising:
(a) selecting a set of customers;
(b) selecting an industry;
(c) determining an industry share of wallet for each customer within the selected set of customers;
(d) ranking each customer within an industry based on the customer's industry share of wallet; and
(e) determining that a customer is an industry passionate consumer when the customer's ranking based on the customer's industry share of wallet exceeds a filtering threshold.

2. The computer-implemented method of claim 1, wherein the set of customers includes all customers of a financial transaction company.

3. The computer-implemented method of claim 1, wherein the set of customers includes a subset of all customers of a financial transaction company.

4. The computer-implemented method of claim 1, wherein the industry comprises at least one of:
an airline industry;
a lodging industry;
a restaurant industry;
a consumer electronics industry;
a fashion industry;
a home improvement industry;
a home furnishings industry; and
an entertainment industry.

5. The computer-implemented method of claim 1, wherein the first threshold includes the top 25% ranked customers based on the customer's industry share of wallet.

6. The computer-implemented method of claim 1, wherein the set of customers comprise at least one of:
customers having a wallet size greater than or equal to a first threshold and less than or equal to a second threshold; and
customers having a wallet size greater than the second threshold.

7. The computer-implemented method of claim 1, wherein a customer is analyzed as to whether the customer is an industry passionate consumer by the use of an industry passionate modeling analysis when less than a predetermined amount of the customer's transactions are with the financial transaction company.

8. The computer-implemented method of claim 7, wherein a customer is analyzed as to whether the customer is an industry passionate consumer by the use of the industry passionate modeling analysis and based upon the customer's industry share of wallet ranking when less than the predetermined amount of the customer's transactions are with a financial transaction company.

9. An industry passionate consumer identification system, comprising:
a customer selection module which identifies a customer of a financial transaction company;
an industry selection module which identifies an industry in which the customer spends a portion of the customer's wallet;
an industry share module which determines an industry share of wallet for the customer;
a ranking module which ranks the customer within the industry based on the customer's industry share of wallet; and
a industry passionate determination module which determines whether the customer is an industry passionate consumer based on the customer's industry share of wallet.

10. The system of claim 9, wherein the industry passionate determination module determines that the customer is an industry passionate consumer when the customer's industry share of wallet is in the top 25% of customers ranked by industry share of wallet.

11. The system of claim 9, wherein the industry passionate determination module determines that the customer is an industry passionate consumer by the use of an industry passionate modeling analysis when less than a predetermined amount of the customer's transactions are with a financial transaction company.

12. The system of claim 11, wherein the industry passionate determination module determines that the customer is an industry passionate consumer by the use of an industry passionate modeling analysis and the customer's industry share of wallet ranking when less than the predetermined amount of the customer's transactions are with the financial transaction company.

13. A computer program product comprising a computer usable medium having control logic stored therein for causing a computer to identify industry passionate consumers, comprising:
first computer readable program code that causes the computer to select a set of customers;
second computer readable program code that causes the computer to select an industry;
third computer readable program code that causes the computer to determine an industry share of wallet for each customer within the selected set of customers;
fourth computer readable program code that causes the computer to rank each customer within an industry based on the customer's industry share of wallet; and
fifth computer readable program code that causes the computer to determine that a customer is an industry passionate consumer when the customer's ranking based on the customer's industry share of wallet exceeds a filtering threshold.

14. The computer program product of claim 13, wherein the filtering threshold includes the top 25% ranked customers based on the customer's industry share of wallet.

15. The computer program product of claim 13, further comprising:
sixth computer readable program code that causes the computer to analyze whether the customer is an industry passionate consumer by the use of an industry passionate modeling analysis when less than a predetermined amount of the customer's transactions are with the financial transaction company.

16. The computer program product of claim 13, further comprising
sixth computer readable program code that causes the computer to analyze whether the customer is an industry passionate consumer by the use of the industry passionate modeling analysis and based upon the customer's industry share of wallet ranking when less that the predetermined amount of the customer's transactions are with a financial transaction company.

17. The computer program product of claim 13, wherein the set of customers includes all customers of a financial transaction company.

18. The computer program product of claim 13, wherein the set of consumers includes a subset of all customers of a financial transaction company.

19. The computer program product of claim 13, wherein the fifth computer readable program code includes:
sixth computer readable program code that causes the computer to perform a first industry passionate analysis on a subset of consumers having a wallet size below a given threshold; and
seventh computer readable program code that causes the computer to perform a second industry passionate analysis on a subset of consumers having a wallet size above the given threshold.
